(19) United States
(12) Patent Application Publication
(10) Pub. No.: US 2015/0279161 A1
(43) Pub. Date: Oct. 1, 2015

(54) SYSTEM AND METHOD FOR GAME CALCULATION

(71) Applicant: Raymond A. Capelli, Whiting, NJ (US)

(72) Inventor: Raymond A. Capelli, Whiting, NJ (US)

(21) Appl. No.: 14/225,259

(22) Filed: Mar. 25, 2014

(51) Int. Cl. G07F 17/32; G06F 15/00

(52) U.S. Cl. CPC G07F 17/3258; G06F 15/00; G07F 17/3288

(57) ABSTRACT

A computer-implemented method for progressive betting including the steps of receiving a first entry from a user corresponding to a TO WIN value and receiving a second entry from the user corresponding to an ODDS value. Determining in a computer without intervention of the user, a BET value representative of an amount to bet for a single race entrant for an entrant race from the first entry and the second entry. Accepting the BET value and accepting the TO WIN value if the BET value for the entrant race is evenly divisible by at least one of 2 or 5. Increasing the BET value to a first nearest dollar divisible by at least one of 2 or 5 dollars if the BET value for the horse race is unevenly divisible by one of 2 dollars or 5 dollars.

### FIELD OF THE INVENTION

The invention generally relates to calculation system and method, and more particularly, to a portable device configured and operative to be used for race track betting.

### BACKGROUND OF THE INVENTION

Many improvements have been made over the years in the design and formatting of hand held calculators. Some of the early simple calculators included a keyboard with the standard functions of multiplication, division, addition, subtraction, decimal point, a clear key and an on-off key, and a display with a single display line. Later scientific calculators incorporated various operating modes, exponential displays, order of operations and levels, calculation range and scientific notation, overflow and error check. Still other scientific calculators incorporated trigonometric/inverse functions (with angle in degrees, radians or grads), hyperbolic/inverse hyperbolic functions, common/natural logarithms, exponential functions (common antilogarithms, natural antilogarithms), powers, roots, square roots, cube roots, squares, reciprocals, factorials, conversion of coordinate system, random number, Pi, fractions, percentages, memory store, and memory recall. The power source was either of batteries, or solar light panels. Other hand held calculators had large screens or displays for simple calculations, calendar, time and date, world time, alarm, memory store, and memory recall. These general purpose calculators have a single housing including a display and keyboard, while other calculators have two piece hinged type housings having the display in one section and the keyboard in the other section.

In addition to general purpose calculators, there are dedicated types of calculators available such as mortgage calculators to calculate rates, mortgage payments, saving closing costs, pmi, etc., financial calculators, calculators having stopwatch functions, metric and degree-minute-seconds conversions calculators, algebraic (logic) operating system calculator, graphing calculator, etc.

For instance, U.S. Pat. No. 5,335,193 (hereinafter “the '193 patent”) discloses a scientific calculator. To use the calculator disclosed in the '193 patent for a dedicated purpose, say, as a calculator which can be employed for the racing sport, many entries can be made using the memory store and memory recall keys while applying multiplication, division and addition for a first race. The result is stored in memory and recalled for a second race, repeating the same operations required in the first race and subsequent races. A user of the calculator disclosed in the '193 patent makes an entry, uses memory, memory recall, division, multiplication and addition for one race, then repeats the same operations for subsequent races. Such operations are time consuming and not conducive to placing “last-minute” bets with ever-changing odds while on the betting line.

Another example can be found in U.S. Pat. No. 4,035,627 (hereinafter “the '627 patent”) which discloses a battery operated, hand held scientific calculator which can perform arithmetic, trigonometric, and logarithmic functions and display the results thereof. The calculator disclosed in the '627 patent is also provided with a clock mode which performs the functions of a clock and displays real time or the functions of a stopwatch and stores and displays the times at which recorded events have taken place. As a scientific calculator, the calculator disclosed in the '627 patent has the same problems as the calculator disclosed in the '193 patent, wherein many operations are required when used in the context of the racing sport.

### SUMMARY OF THE INVENTION

The present invention generally relates to computer-implemented method for progressive betting including the steps of receiving a first entry from a user corresponding to a TO WIN value and receiving a second entry from the user corresponding to an ODDS value. Determining in a computer without intervention of the user, a BET value representative of an amount to bet for a single race entrant for an entrant race from the first entry and the second entry. Accepting the BET value and accepting the TO WIN value if the BET value for the entrant race is evenly divisible by at least one of 2 or 5. Increasing the BET value to a first nearest dollar divisible by at least one of 2 or 5 dollars if the BET value for the entrant race is unevenly divisible by one of 2 dollars or 5 dollars.

In one aspect, the present invention overcomes the disadvantages and shortcomings of the prior art discussed above by providing a portable electronic computer. In an illustrated embodiment, which the invention is not to be understood to be limited thereto, a portable computer device is provided having a dedicated program which provides a sequential step-by-step flashing display directing the user to an entry required for a specific function. The program fast tracks the complex calculations of multiplication, division, addition and memory storage required to calculate a “bet” to a single entry and to incorporate a “bet” function into “lost” or “won” functions. Calculator functionality is provided with a program adding a “LOST BET” to a “TO WIN” entry, establishing a new “TO WIN” amount for subsequent races and recalculating the TO WIN value in accordance with the increased bet value, and accepting the TO WIN value.

Preferred embodiments of the present invention provide for a battery powered, hand held calculator having the standard electronic functions of the basic calculation operations of addition, subtraction, multiplication and division, with an exponential display function. The calculator has a temporary power-off programmed by the user and a program designed for the racing sport. The program, executed by a processor, dictates an entire set of instructions to and from flashing fields of the display with their respective numerical entries, and operates on inputs entered by a user into the numerical keyboard and function keys, with the final calculations performed by the processor. The calculator has a keyboard with ten numerals from 0 to 9, six function keys including a “TO” designation used to separate ODDS numerical entries, an “E” key as enter, a “C” key as clear, an AC KEY (ON) to start the calculator, an “L” key for LOST, a “W” key for WON, and the C/AC keys together (or in that order) to shut down the calculator. The “TO” and “E” keys can be actuated together as a temporary power-off of the calculator while the memory of the program is retained. To re-store power and the program to its current state, the “AC” key is pressed which restores the last display and status of the calculator.

In preferred embodiments of the present invention, the calculator has a six line step-by-step sequentially flashing display for preventing errors of omitted calculations steps by the user. The six line display includes a “TO WIN” field providing an eight digit numerical entry, an “ODDS” field providing a three digit numerical entry, a “TO” designation separating “ODDS” entries, and a two digit numerical entry a “BET” field providing an eight digit numerical entry, a “LOST” field providing an eight digit numerical entry, a “WON” field providing an eight digit numerical entry, and a “RACE” field providing a two digit numerical entry. Other embodiments of the invention may include a display with fewer than six lines. The calculator can automatically record the number of events or races entered. The calculator is provided with a method turnoff turning OFF the calculator by pressing the “C” and “AC” keys on the keyboard simultaneously, or by first holding down the “C” key followed by the “AC” key, thereby minimizing an accidental swipe of a single OFF key which could delete memory. The calculator can also be provided with the functionality to automatically calculate a “bet” amount to the nearest highest dollar or dollars and cents that is incrementally increased by “X” cents, and as whole numbers in increments of 2 or 5 dollars, which is acceptable to race track betting standards. The calculator can also prompt the processor to recalculate a “TO WIN” numerical amount when the “BET” amount was not in increments of 2 or 5 dollars. The calculator can be provided with a program using a progressive method of betting on the favorites using race track statistics, where, for example, 22% to 28% of the favorites win at a race track meet.

It is contemplated that the functionality of the calculator can be implemented in a cell phone, and/or any portable wireless device, with or without expansion card capability, and that has a display with an alpha-numeric and/or other function keyboard. It is contemplated that embodiments of the present invention can be provided in connection with a hand held device, e.g., a Blackberry® device, etc., and/or can be simulated on the screen of a computer, etc., with code for simulating the calculator being stored on a machine-readable medium such as a compact disc, DVD, floppy disc, hard disc, etc. It is contemplated that the alphanumeric and/or or function keys of the cell phone and/or other portable wireless devices can perform the same functions as the stand alone calculator.

Further features and advantages of the invention will appear more clearly on a reading of the following detailed description of two exemplary embodiments of the invention.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1A illustrates an exemplary computer system according to an illustrated embodiment of the invention.

FIG. 1B is a front elevation view of a battery operated hand held calculator customized for the racing sport, the calculator being constructed in accordance with a first exemplary embodiment of the present invention to have a six line display;

FIG. 2 is a side elevation view of the calculator of FIG. 1;

FIG. 3 is a front elevation view of a battery operated hand held calculator customized for the racing sport, the calculator being constructed in accordance with a second exemplary embodiment of the present invention to have a three line display;

FIG. 4 depicts the display of the calculator of FIG. 3, wherein the display is shifted to show a numerical designation of the current race;

FIG. 5 depicts the display of the calculator of FIG. 3, wherein the display is shifted to show the “ODDS”, “BET”, and “LOST” fields;

FIG. 6 depicts the display of the calculator of FIG. 3, wherein the display is shifted to show the “ODDS”, “BET”, and “WON” fields;

FIG. 7 depicts the display of the calculator of FIG. 3, wherein the display is shifted to show initial fields upon power-up including the “TO WIN”, “ODDS”, and “BET” fields;

FIG. 8 depicts the display of the calculator of FIG. 3, wherein the display is shifted to show fields upon winning a bet, including the “TO WIN”, “WON”, and “RACE” fields;

FIGS. 9A, 9B, and 9C are three parts of a continuous flow chart showing processing steps of the main control program executed by a processor of the calculator of FIG. 1; and

FIGS. 10A, 10B, and 10C are three parts of a continuous flow chart showing processing steps of the main control program executed by a processor of the calculator of FIG. 3.

### WRITTEN DESCRIPTION OF CERTAIN EMBODIMENTS OF THE INVENTION

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

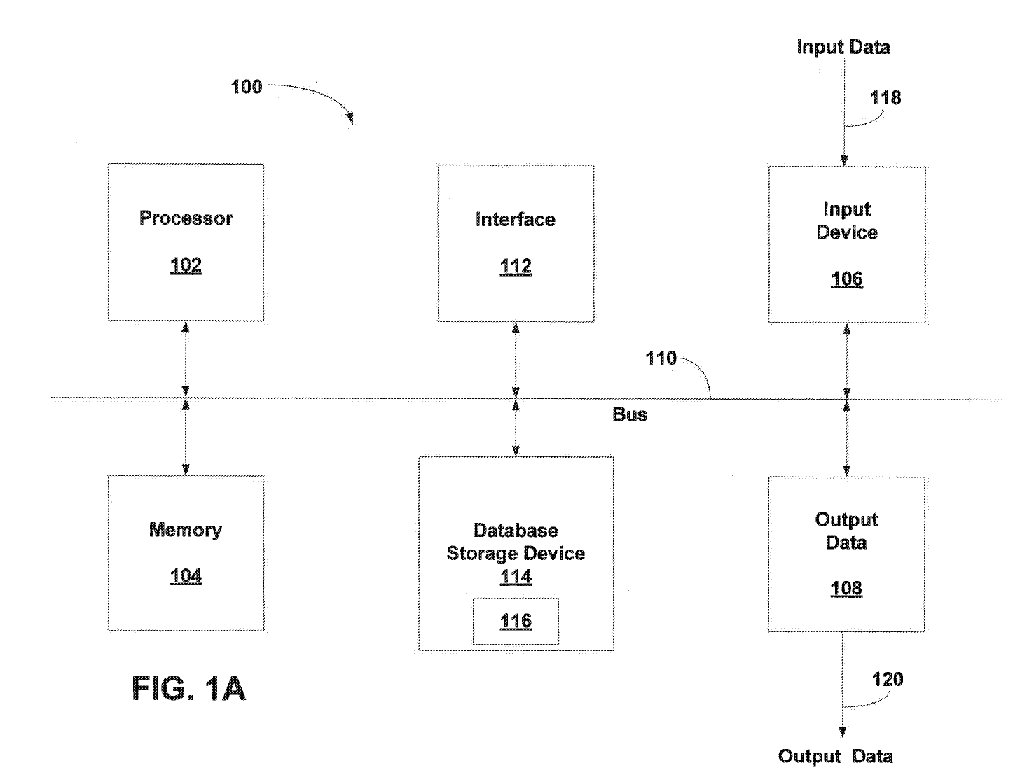

Turning now descriptively to the drawings, in which similar reference characters denote similar elements throughout the several views, FIG. 1A depicts an exemplary general-purpose computing system in which illustrated embodiments of the present invention may be implemented.

A generalized computering embodiment in which the present invention can be realized is depicted in FIG. 1A illustrating a processing system 100 which generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or nonvolatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

It is to be appreciated that the processing system 100 may be a part of a networked communications system. Processing system 100 could connect to a network, for example the Internet or a WAN. Input data 118 and output data 120 could be communicated to other devices via the network. The transfer of information and/or data over the network can be achieved using wired communications means or wireless communications means. A server can facilitate the transfer of data between the network and one or more databases. A server and one or more databases provide an example of an information source.

Thus, the processing computing system environment 100 illustrated in FIG. 1A may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1A include a local area network (LAN) and a wide area network (WAN), but may also include other networks such as a personal area network (PAN). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1A are exemplary and other means of establishing a communications link between multiple computers may be used.

FIG. 1A is intended to provide a brief, general description of an illustrative and/or suitable exemplary environment in which embodiments of the below described present invention may be implemented. FIG. 1A is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system environment 100 of FIG. 1A. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, tablet devices (e.g., APPLE® IPAD), smart phone devices (e.g., APPLE® IPHONE) and distributed computing environments that include any of the above systems or devices.

Embodiments may be described in a general context of computer-executable instructions, such as program modules, being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

With the exemplary computing system environment 100 of FIG. 1A being generally shown and discussed above, an illustrated embodiment of the present invention incorporating components of system 100 (FIG. 1A) will now be discussed below. It is to be understood and appreciated that while a below illustrated embodiment of the present invention is discussed in terms of a hand held electronic calculator 5 having dedicated electronics, it is not be understood to be limited to this illustrated embodiment as it is to be understood and appreciated the present invention may be integrated, incorporated with or otherwise used with any computing systems, environments, and configurations that may be suitable for use with the present invention, including, but not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, tablet devices (e.g., APPLE® IPAD), smart phone devices (e.g., APPLE® PHONE) and distributed computing environments that include any of the above systems or devices.

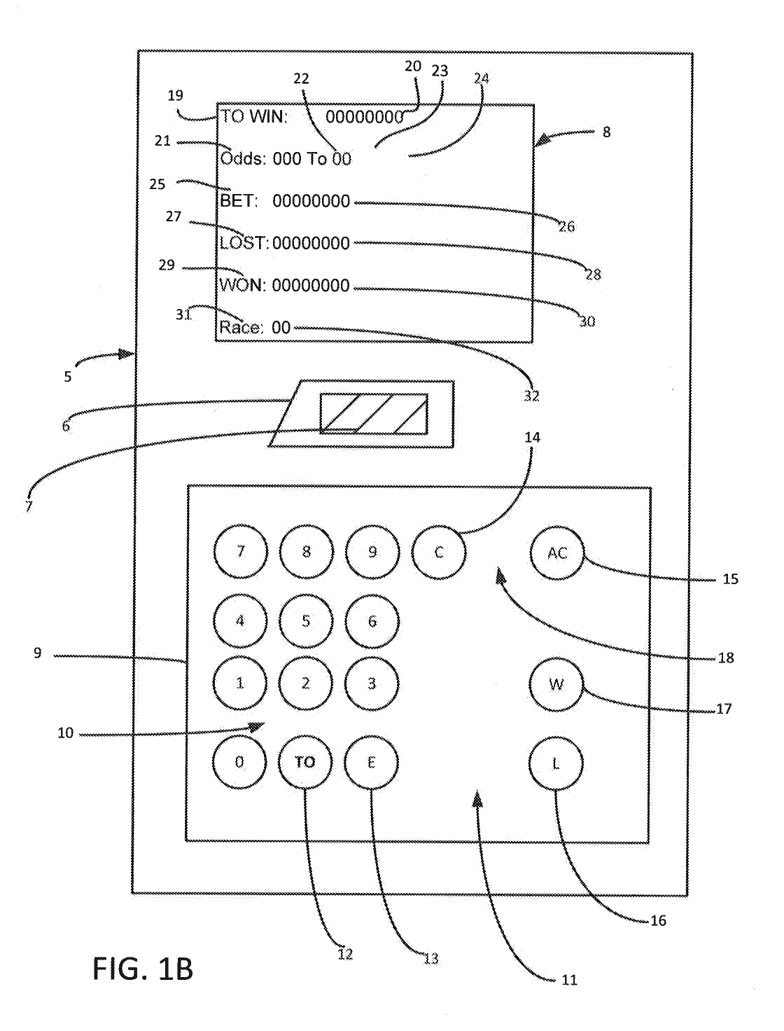

Referring now to FIGS. 1B and 2 (with continuing reference to FIG. 1A), in accordance with an illustrated embodiment a battery powered, hand held electronic calculator 5, constructed in accordance with an exemplary embodiment of the present invention is depicted. In this illustrated embodiment, the electronic calculator 5 has internal electronics 6 including a processor 7 incorporating a program that dictates an entire set of instructions for running the calculator 5. However, and as mentioned above, the electronic calculator of the present invention may be a software application, code or module configured and operative to be used with any computing systems, environments, and configurations that may be suitable for use with the present invention, including, but not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, tablet devices (e.g., APPLE® IPAD), smart phone devices (e.g., APPLE® IPHONE) and distributed computing environments that include any of the above systems or devices.

The electronic calculator 5 is preferably provided with a display 8 and a keyboard 9. In an illustrated embodiment, the calculator 5 has a six line display 8. The six lines of the display 8 includes a “TO WIN” field 19 with an eight digit numerical entry 20, an “ODDS” field 21 and a “TO” designation 23 with a three digit numerical entry 22 before the “TO” designation 23 and a two digit numerical entry 24 after the “TO” designation 23, a “BET” field 25 with an eight digit numerical entry 26, a “LOST” field 27 with an eight digit numerical entry 28, a “WON” field 29 with an eight digit numerical entry 30, and a “RACE” field 31 with a two digit numerical entry 32. The display 8 can optionally display numerals and calculations in exponential notation, and can have a temporary power-off function while maintaining the current state of memory of the calculator 5.

The keyboard 9 preferably includes keys for numerals 10 from zero (0) to nine (9) and six function keys 11. The six function keys 11 include a “TO” key 12 for separating the “ODDS” numeric entry 22 of the display 8 from an “ODDS” numeric entry 24, an “E” key 13 used as an enter key, a “C” key 14 used as a clear key, an “AC” key 15 for starting the calculator 5, an “L” key 16 for activating the “LOST” field of the display 8, a “W” key 17 for activating the “WON” field of the display 8, and a “C” key 14 which is pressed simultaneously with the “AC” key 15 (or after the “AC” key 15) to shut down the calculator 5. The “TO” key 12 and the “E” key 13 can be pressed simultaneously (or in that order) to provide a temporary power-off of the calculator while the calculator retains its memory and last state. To restore power, memory, and last state, the “AC” key 15 is then pressed. The calculator 5 can also be provided with standard electronic function keys (not shown) for the basic calculation operations of addition, subtraction, multiplication and division. It is contemplated that the calculator 5 can be provided with additional keys, such as when the calculator 5 is integrated with a cell phone, a hand-held device, e.g., a Blackberry® device, etc., or any portable wireless devices with or without expansion card capability and having a display with an alpha-numeric and/or other function keyboard, etc.

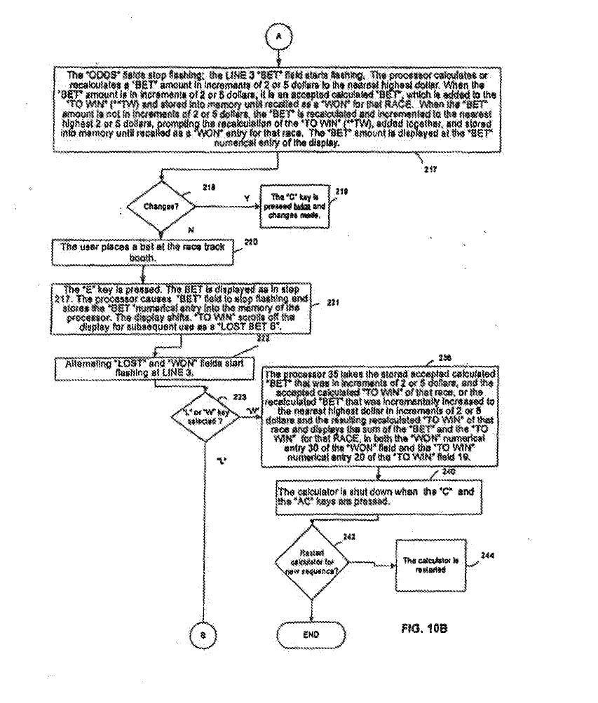

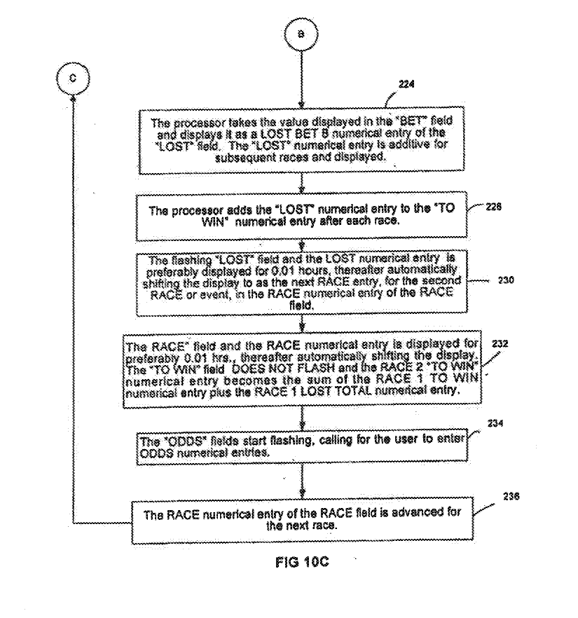

FIGS. 9A-9C are three parts of a continuous flow chart of the steps executed by the main program stored in the memory of the calculator 5. Referring now to FIGS. 1 and 9, at step 100, the “AC” key 15 (ON) of the calculator 5 is used to initialize the program stored within the processor 7. At step 102, the processor 7 causes the electronics 6 to display the “TO WIN” 19, “ODDS” 21, “BET” 25, “LOST” 27, “WON” 29 and “RACE” 31 fields with their respective numerical entries on the display 8. The “RACE” numerical entry 32 of the “RACE” field 31 initially displays a “01” denoting the first “RACE” or entry. The “RACE” numerical entry 32 automatically advances to the next highest number after each race or event. At step 104, the processor 7 causes the “TO WIN” field 19 on the display 8 to flash, which functions as a prompt for the user to enter numerical entry 20. At step 106, using the keyboard numerals 10 the numeric “TO WIN” amount is entered. If, at step 107, a change is to be made (e.g., to correct an error), then at step 108, the “C” key 14 from the function keys 11 is pressed to clear the numerical entry 20 and changes are entered. If no correction is made, or if the correction has already been entered, then at step 110, the “E” key 13 is pressed which causes the processor 7 to display the numerical entry 20 and to store its value into the memory of the calculator 5. At step 112, the processor 7 causes the “TO WIN” field 19 of the display 8 to stop flashing and causes the “ODDS” field 21 and the “TO” designation 23 of the display 8 to begin flashing, which prompt the user to enter the numerical entries 22, 24. At step 114, the values for the numerical entry 22 of the “ODDS” field 21 is entered. At step 116, the “TO” key 12 of the function keys 11 is pressed. At step 118, the numerical entry 24 of the “ODDS” field 21 is entered. At step 120, if changes are to be made, then at step 121, the “C” key 14 of the function keys 11 is pressed to cause the processor 7 to clear the entries 22, 24. If no correction is made, or if the correction has already been entered, then at step 122, the “E” key 13 of the function key 11 is pressed, which causes the processor 7 to display the numerical entries 22, 24 and to store their values into the memory of the processor 7. At step 124, the processor 7 causes the “ODDS” fields 21 and 23 to stop flashing and causes the “BET” field 25 to start flashing. Using the “TO WIN” value and the ODDS value, the processor 7 calculates or recalculates a “BET” amount in increments of two and/or five dollars to the nearest high dollar. When the “BET” amount is in increments of 2 or 5 dollars, it is an accepted calculated “BET”, which is displayed, and added to the **TO WIN“ (**TW) and stored into memory until recalled as a “WON” value for that RACE. When the “BET” is not in increments of 2 or 5 dollars, the “BET” is recalculated by adding cents incrementally and rounded up to the nearest highest 2 or 5 dollars and displayed. This prompts the recalculation of the “TO WIN” (**TW), added together (e.g., B+**TW=W), and stored into memory until recalled as a “WON” entry for that RACE.

The “WON” value is preferably representative of that amount of money which a user would collect from a race track cashier after a win, which includes a return of the bet placed, as well as provision of the winnings. For example, if a user had provided the cashier with a $25 bet at 2-to-1 odds and the user wins the bet, then the WON value is preferably equal to $75. In this regard, preferred embodiments of the invention put the user on notice of that gross amount of money to collect from the cashier. It is contemplated that the WON value, in some embodiments of the invention, can be made to be representative of the winnings, e.g., **TW=W, such that the display of the WON value provides to the user a more direct measure of net gain.

At step 125, if changes are to be made, such as last minute changes of the “ODDS” entries, 22, 24 and the “BET” entry 26, then at step 126, the “C” key 14 of the function keys 11 is pressed two (2) times to clear the last “ODDS” and “BET” entries. The new “ODDS” 22, 24 entries are entered as described above. If no changes are to be made, or if the user has already made changes, then at step 127, the user places a “BET” at the race track booth corresponding to the amount of money indicated in the “BET” numerical entry 26. At step 130, the “E” key 13 of the function keys 11 is pressed, which stops the “BET” 25 from flashing and stores the “BET” numerical entry into the memory of the processor 7 for subsequent use as a “LOST BET B.” At step 132, The “LOST” 27 and “WON” 29 fields start flashing, the processor 7 awaiting the user to determine whether the “BET” numerical entry 26 was lost or won. The user can select either the “L” key 16 (i.e., the user lost the race) or the “W” key 17 (i.e., the user won the race) of the function keys 11. If, at step 134, the “L” key 16 of the function keys 11 is selected, the “WON” function stops flashing, and the processor 7 performs the following steps:

At step 136, the processor 7 takes the value displayed in the “BET” field 26 from the memory and displays it as a LOST BET B numerical entry 28 of the “LOST” field 27 on the display 8. The “LOST” numerical entry 28 is additive for subsequent races and displayed. The program for the LOST TOTAL numerical entry 28, expressed as L1, where 1 is an integer greater than or equal to 1, is as follows:

RACE 1: L1

RACE 2: L1+LOST BET B=L2

RACE 3: L2+LOST BET B=L3

RACE 4: L3+LOST BET B=L4

RACE 5: L4+LOST BET B=L5

RACE 6: L5+LOST BET B=L6

RACE 7: L6+LOST BET B=L7

RACE 8: L7+LOST BET B=L8, etc.

At step 138, the processor 7 adds the “LOST” numerical entry 28 to the “TO WIN” (TW) numerical entry 20 for RACE 2, and at step 140, the total is displayed in the “TO WIN” numerical entry 20 for the next race. The “TO WIN” numerical entry 20 is equal to the RACE 1 “TO WIN” numerical entry plus the “LOST TOTAL” numerical entry 28 of the previous RACE. The program is expressed as follows (also see TABLE 4):

RACE 1: TW

RACE 2: TW+L1=TW2*

RACE 3: TW+L2=TW3*

RACE 4: TW+L3=TW4*

RACE 5: TW+L4=TW5*

RACE 6: TW+L5=TW6*

RACE 7: TW+L6−TW7*

RACE 8: TW+L7=TW8*, ETC.

In a preferred embodiment, the “TO WIN” cannot be changed by the user after the “BET” is placed at the race track booth in RACE 1.

At step 142, the “LOST” field 27 stops flashing and the “ODDS” fields 21, 23 start flashing for the numerical entries 22, 24, which restarts the procedure as stated above. At step 144, the RACE numerical entry 32 of the “RACE” field 31 is advanced to 02 for the second RACE, 03 for the third RACE, etc.

If at step 134, the “W” key 17 of the function keys 11 is selected, then at Step 148, the processor 7 takes from the memory stored in Step 124, the stored accepted calculated “BET” that was in increments of 2 or 5 dollars, and the accepted calculated “TO WIN” of that RACE (or the recalculated “BET” that was incrementally increased to the nearest highest dollar in increments of 2 or 5 dollars and the resulting recalculated “TO WIN” of that RACE) and displays the sum of the “BET” and “TO WIN” of either the accepted calculated “BET” and “TO WIN” (or the recalculated “BET” and “TO WIN”, as the case may be) for that RACE in both the “WON” numerical entry 30 of the “WON” field 29 and the “TO WIN” numerical entry 20 of the “TO WIN field 19. The “WON” and “TO WIN” fields continue to flash. The WON program is expressed as follows (and as shown in Table 4):

RACE 1: **TW+B=W1 where “BET B” is in increments of 2 or 5: TW (TO WIN) is accepted; **TW+B=W1 where “BET B” and **TW (TO WIN) are recalculated,

RACE 2: **TW2+B=W2 where “BET B” is in increments of 2 or 5: TW (TO WIN) is accepted; **TW+B=W2 where “BET B” and **TW (TO WIN) are recalculated,

RACE 3: **TW3+B=W3, etc.

“B” or “BET B” is used as an accepted BET in increments of 2 or 5 dollars and/or as a recalculated BET to bring it to increments of 2 or 5 dollars.

The “WON” field 29 and the TO WIN field 19 keep flashing. In a preferred embodiment, no further entries can be made as the user has met his “TO WIN” goal. At step 150, the user can shut the calculator 5 by pressing the “C” key 14 and the “AC” key 15 on the keyboard 9 simultaneously (or one after the other). If the user wants to begin a new betting sequence at step 152, then at step 154, the calculator 5 is restarted.

In a preferred embodiment, the calculator 5 can be temporarily switched off while retaining its memory and last state in the processor 7. This is accomplished by pressing the “TO” key 12 and the “E” key 13 simultaneously (or in that order). To restore power and memory, the “AC” key 15 is pressed by the user.

Table 1 below shows the arrangement of the keyboard 9 and display 8 of the calculator 5.

TABLE 1

| | | | | | |
|---|---|---|---|---|---|
| Keyboard: | 7 | 8 | 9 | C | AC |
| | 4 | 5 | 6 | | |
| | 1 | 2 | 3 | | W |
| | 0 | To | E | | L |

| | |
|---|---|
| Display | TO WIN: 00000000 |
| functions: | ODDS: 000 TO 00 |
| | BET: 00000000 |
| | LOST: 00000000 |
| | WON: 00000000 |
| | RACE: 00 |

The following are sample operations performed for a hypothetical Race #1:
A) Using the keyboard 9, the “AC” key 15 (ON) is pressed to start the commands of the processor 7, which causes the electronics 6 of the calculator 5 to display the “TO WIN”, “ODDS”, “BET”, “LOST”, “WON” and “RACE” fields in the display 8 with their respective numerical entries.
B) The “TO WIN” field 19 automatically flashes in the display 8 calling for a numerical entry using the keyboard numerals 10 (the amount to be determined by the user for the day or event).
C) Using the keyboard 9, the “TO WIN” numerical amount is entered using the keyboard numerals 10. The “E” key 13 on the keyboard 9 is pressed to enter the displayed numerical amount into the calculator memory. If a change is to be made before the “E” key 13 is pressed, the “C” key 14 on the keyboard 9 is pressed to clear a numerical entry. The new “TO WIN” numerical amount is entered, then the “E” key 13 is pressed to enter it into memory. The “TO WIN” field 19 on the display 8 stops flashing and the next “ODDS” field 21 and “TO” designation 23 start flashing calling for a numerical entry to be made. The “TO WIN” amounts are expressed as “TW” or TW* for subsequent races. The calculated or recalculated amount is expressed as **TW which is used to add a bet amount to obtain a “WON” amount (see STEP #1 or STEP #2 below).
D) Using the keyboard 9, the user enters the “ODDS” by entering a numerical value followed pressing the “TO” key 12 followed by pressing another numerical entry. For example, for 2:1 “ODDS”, the user presses the number 2 followed by the “TO” key 12 followed by pressing the number 1. If changes are to be made, the “C” key 14 on the keyboard 9 is pressed to clear the entry. The user then enters the new “ODDS”. After the change, or if there were no changes, the “E” key 13 on the keyboard 9 is pressed which stops the “ODDS” field from flashing and causes the processor 7 to enter the “ODDS” numerical entry into the memory. Then the “BET” field starts flashing. The “ODDS” entries are expressed as “C:D”.
E) After the “TO WIN” AND “ODDS” numerical entries are made, calculations are automatically made by the processor 7 for the “BET” numerical entry amount and this amount (as in step 1, either calculated or recalculated) is displayed in the numerical entry 26. After the user places a bet at the race track corresponding to the “BET” numerical entry amount, the “E” key 13 on the keyboard 8 is pressed, which causes the processor 7 to stop the “BET” function from flashing and to store the “BET” numerical entry amount into the memory of the calculator 5 for subsequent use either as a LOST BET B when the “L” key 16 on the keyboard is pressed, or to add the “BET” numerical entry amount (see STEP #1 below) to the **“TO WIN” calculated or recalculated amount when the “W” key 17 is pressed as in Steps 1 and 2 below. For last minute changes of the “ODDS” and “BET” numerical entries BEFORE the “E” key 13 is pressed, the “C” key 15 on the keyboard is pressed two (2) times, which clears the last “ODDS” and “BET” numerical entries. The new “ODDS” are entered, then the “E” key 13 is pressed. After the user places the displayed “BET” numerical entry amount at the race track, the “E” key 13 is pressed to store the BET numerical entry amount into the memory of the processor 7 to restart the procedure. The “BET” numerical amount is expressed as “B”. The “LOST” and “WON” fields then flash while the processor 7 awaits for the user to determine whether the “BET” numerical entry amount was “LOST” or “WON, whereby the user can press either the “L” key 16 or the “W” key 17 on the keyboard 9.
F) The flashing of the “LOST” or “WON” display functions requires the user to determine whether the race was “LOST” or “WON”. If the race was “LOST”, the “L” key 16 on the keyboard 9 can be pressed, whereby the “BET” numerical entry amount stored in the memory of the processor 7 can be displayed as a “LOST” numerical entry amount and then entered into the memory as a LOST BET B (L1). The LOST BET B is additive after each “LOST” race. The “LOST BET B” numerical entry amount is expressed as “L1” for RACE 1. If the user has lost RACE 1, the “L” key 16 can be pressed, which causes the WON/LOST display field to stop flashing. A new “TO WIN” (TW2*) numerical entry amount is displayed for RACE 2 as the sum of the RACE 1, “TO WIN*” numerical entry amount (TW*), plus the RACE 1 “LOST” numerical entry amount (L1). The “TO WIN” value for RACE #2 is expressed as TW+L1=TW2*, (The RACE 3 “TO WIN” numerical entry amount is expressed as the RACE 1 “TO WIN” numerical entry amount plus the RACE 2 “LOST” numerical entry amount and is expressed as TW2+L2=TW3*, etc.). The “ODDS” function for RACE 2 starts flashing, which prompts the user to enter another numerical entry.
G) If the RACE was “WON”, the “W” key 17 on the keyboard 9 can be pressed. The “WON” value for RACE 1 is equal to the sum of the **“TO WIN” calculated amount of RACE 1 plus the BET (B) calculated numerical amount of RACE 1 (see STEP #1 below), or, the recalculated “TO WIN” numerical amount and the recalculated “BET B” numerical amount (STEPS #1 and #2) taken from the memory of the processor 7 (from STEP 124) of the calculator 5 and is displayed as both the “WON” and “TO WIN” flashing fields with their respective numerical entry amounts. The “WON” program for RACE 1 is expressed as **TW+B=W1 (“WON”), When the “W” key 17 is pressed, the “LOST” field 27 stops flashing. In a preferred embodiment, the user does not make further entries in the calculator 5 since the “TO WIN/WON” goal was met. In such circumstances, the user shut down the calculator 5 by pressing the “C” key 14 and the “AC” key 15 simultaneously (or one after the other, Note: **TW=calculated or recalculated as shown below in STEP #1 and STEP #2). However, it is contemplated that further entries can be made.
H) The RACE number on the display 8 can indicate either the number of the race or number of entries made, and not necessarily the start of the first race at the track. At the start up of the calculator 5, RACE 1 appears. With each “LOST” entry, the next RACE number is automatically displayed.

The following are sample operations to be performed for a hypothetical Race #2 and higher:
A) If the RACE 1 was entered as “LOST” after the user has pressed the “L” key 16 on the keyboard, the “LOST” numeric entry amount is displayed and referred to as “L1”. The “TO WIN” numerical entry amount in the memory of the processor 7 and in the display changes for RACE 2 to incorporate the sum of the RACE 1 “TO WIN” numerical entry amount (TW) and the RACE 1 “LOST” numerical amount (L1). The “TO WIN” amount for RACE 2 is expressed as TW+L1=TW2.* For subsequent RACES, the “TO WIN” numerical amount in the memory and on the display 8 is equal to the sum of the RACE 1 “TO WIN” numerical entry amount plus the previous “LOST” RACE numerical entry amount, and is expressed as: RACE 3=TW+L2=TW3*, RACE 4=TW+L3=TW4*, RACE 5=TW+L4=TW5*, RACE 6=TW+L5=TW6*, RACE 7=TW+L6=TW7*, RACE 8=TW+L7=TW8*, etc. At this time, the “ODDS” field 21 and the “TO” designation 23 start flashing to alert the user to make a subsequent numerical entry.
B) Using the keyboard, the user then enters the “ODDS” by pressing number(s) on the keyboard 9, the “TO” key 12 on the keyboard 9, and another set of number(s) on the keyboard 9. For example, for 2:1 “ODDS”, the user presses the number 2, followed by the “TO” key 12 followed by the number 1 on the keyboard 9. If changes are to be made, the user presses the “C” key 14 on the keyboard 9 to clear the entry. The user then enters the new “ODDS” as described above. After the change, or if there were no changes, the “E” key 13 on the keyboard 9 is pressed, which causes the processor 7 to stop the “ODDS” field 21 from flashing and causes the “ODDS” numerical entries to be entered into the memory of the processor 7. This in turn causes the “BET” field 25 to flash. The “ODDS” are expressed as “C:D”.
C) Using the RACE 2 “TO WIN” numerical entry amount (TW+LI=TW2*) with the RACE 2 “ODDS” numerical entries, the processor 7 automatically makes calculations for the “BET” amount (see STEP #1 followed by STEP #2 below) and displays for the “BET” numerical entry amount on the display 8. After the user places the “BET” numerical amount at the race track booth, the user can then press the “E” key 13, whereby the “BET” numerical entry is stored into the memory of the processor 7 until the user determines whether the “BET” numerical entry was LOST or WON. If the user LOST the BET, the user can then press the “L” key 16 on the keyboard 9, wherein the stored “BET” numerical entry is transferred into the memory of the processor 7 and the “LOST” numerical amount can be added to any previous “LOST” numerical amounts and displayed. When the “L” key 16 is pressed, the “BET” numerical entry becomes a “LOST BET B” (either calculated or recalculated) in the memory of the processor 7 and is expressed as L2=L1+LOST BET B=L2 for RACE 2 and used to determine the new “TO WIN” numerical entry amount in the program TW+L2=TW3* for RACE 3. Then for RACE 4, TW+L3=TW4*, etc.
For last minute changes of the “ODDS” and “BET” numerical entries, the “E” key 13 is pressed, the “C” key 14 on the keyboard is pressed two (2) times to clear the last “ODDS” and “BET” numerical entries. The user then enters the new “ODDS” numerical entries as shown above, can then place the displayed “BET” numerical entry amount at the race track booth, and then can press the “E” key 13 to store the “BET” numerical entry amount into the memory of the processor 7 which causes the processor 7 to starting the flashing of the “LOST” field 27 and “WON” field 29. The “BET” amount is expressed as “B”.
D) The flashing of the “LOST” or “WON” fields 27, 29 requires the user to select one of the display functions. If RACE 2 was “LOST”, the user can press the “L” key 16, wherein the BET B amount is added to the RACE 1 “LOST” numerical entry amount, displayed, and then entered into the memory of the processor 7 of the calculator 5 for subsequent races. The “LOST” program for RACE 2 is expressed as L2 (L1+LOST BET B=L2). For RACE 3 the “LOST” program is expressed as L3 (L2+LOST BET B=L3). For RACE 4 the “LOST” program is expressed as L4 (L3+LOST BET B=L4) etc. The RACE 2 LOST program, L2, is used to determine the RACE 3, “TO WIN” numerical entry amount, and is expressed as TW+L2=TW3*. For RACE 4, the “TO WIN” numerical entry amount is expressed as TW+L3=TW4*, for RACE 5, TW+L4=TW5*, etc. After RACE 1, in a preferred embodiment, no further changes may be made to the “TO WIN” numerical entry other than through the program memory as stated above.
E) If the RACE was “WON”, the “W” key 17 on the keyboard can be pressed. The “WON” numerical entry amount for RACE 2 is equal to the sum of the **TO WIN calculated amount of RACE 2, plus the BET (B) calculated numerical amount of RACE 2 (see Step #1 below), OR, The recalculated **TO WIN numerical amount of RACE 2 (Steps #1 and #2 below) and the recalculated BET (B) numerical amount of RACE 2 which is taken from the memory of the processor 7 (from step 124) and is displayed in both the “WON” and the “TO WIN” flashing fields “with their respective numerical entry amounts. The RACE 2 “WON” program is expressed as **TW2+B=W2. The RACE 3 program is expressed as **TW3+B=W3. The RACE 4 program is expressed as **TW4+B=W4. The RACE 5 program is expressed as **TW5+B=W5. The RACE program is expressed as **TW6+B=W6, ETC. NOTE: “B” above is either calculated or recalculated “BET B” in all cases (see Step #1 below)
F) RACE: same as in RACE 1 above.

In a preferred embodiment, no further entries can be made since the “TO WIN” and “WON” goal was met. The user then shuts down the calculator by pressing the “C” key 13 and the “AC” key 14 together (or one after the other).

Table 2 below shows the progression of calculations in exact dollars and cents for a sample sequence of RACES. (Table 2 preferably does not use STEP #1 and STEP #2 shown below. STEPS #1 and #2 are preferably only used in Table 4 since race tracks only accept bets in increments of 2 or 5 dollars, but pay out in dollars and cents. Examples for bets that operate under these conditions will be described in greater detail hereinbelow.)

TABLE 2

| “TO WIN” ($) | 2:1 “ODDS” for all Races | | Race |
|---|---|---|---|
| 50.00 = TW | TW:B::C:D | 50.00:B::2:1 | 1 |
| | TWD = BC | 50.00 = 2B | |
| | TWD −/− C = B | 50.00 −/− 2 = 25.00 BET ″B″ | |
| | B = 25.00 or LOST BET ″B″ = LI (TOT. LOST) | | |
| | TW + B = W1 | 50.00 + 25.00 = 75.00 TOTAL $ WON/TO WIN | |
| TW + LI = TW2 | TW2:B::C:D | 75.00:B::2:1 | 2 |
| 50.00 + 25.00 | TW2D = BC | 75.00 = 2B | |
| TW2 = 75.00 | TW2D −/− C = B | 75.00 −/− 2 = 37.50 BET ″B″ | |
| | B= 37.50 or LOST BET ″B″ | | |
| | LI + LOST BET ″B″ = L2 | 25.00 + 37.50 = 62.50 (TOT. LOST) | |
| | TW2 + B = W2 | 75.00 + 37.50 = 112.50 TOTAL $WON/TO WIN | |
| TW + L2 = TW3 | TW3:B:C:D | 112.50:B::2:1 | 3 |
| 50.00 + 62.50 | TW3D = BC | 112.50 = 2B | |
| TW3 = 112.50 | TW3D −/− C = B | 112.50 −/− 2 = 56.25 BET ″B″ | |
| | B = 56.25 or LOST BET ″B″ | | |
| | L2 + LOST BET ″B″ = L3 | 62.50 + 56.25 = 118.75 (TOT. LOST) | |
| | TW3 + B = W3 | 112.50 + 56.25 = 168.75 TOTAL $ WON/TOWIN | |
| TW + L3 = TW4 | TW4:B::C:D | 168.75:B::2:1 | 4 |
| 50.00 + 118.75 | TW4D = BC | 168.75 = 2B | |
| TW4 = 168.75 | TW4D −/− 2 = B | 168.75 −/− 2 = 84.375 BET ″B″ | |
| | B = 84.375 or LOST BET ″B″ | | |
| | L3 + LOST BET ″B″ = L4 | 118.75 + 84.375 = 203.125 (TOT. LOST) | |
| | TW4 + B = W4 | 168.75 + 84.375 = 253.125 TOTAL $ WON/TO WIN | |
| TW + L4 = TW5 | TW5:B::2:1 | 253.125:B::2:1 | 5 |
| 50.00 + 203.125 | B = 126.562 OR LOST BET ″B″ | | |
| TW5 = 253.125 | L4 + LOST BET ″B″ = L5 = 329.68 (TOT. LOST) | | |
| | TW5 + B = W5 | 253.125 + 126.562 = 379.69 TOTAL $ WON/TO WIN | |
| TW + L5 = TW6 | TW6:B::C:D | 379.69:B::2:1 | 6 |
| 50.00 + 329.69 | B = 189.84 or LOST BET ″B″ | | |
| TW6 = 379.69 | L5 + LOST BET ″B″ = L6 = 519.53 (TOT. LOST) | | |
| | TW6 + B = W6 | 379.69 + 189.84 = 569.53 TOTAL $ WON/TO WIN | |
| TW + L6 = TW7 | TW7:B::C:D | 569.53:B::2:1 | 7 |
| 50.00 + 519.53 | B = 284.77 or LOST BET ″B″ | | |
| TW7 = 569.53 | L6 + LOST BET ″B″ = L7 = 804.30 (TOT. LOST) | | |
| | TW7 + B = W7 | 569.53 + 284.77 = 854.30 TOTAL $ WON/TO WIN | |
| TW + L7 = TW8 | TW8:B::C:D | 854.30:B::2:1 | 8 |

| 50.00 + 804.30 | B = 427.15 or LOST BET ″B″ | |
|---|---|---|
| TW8 = 854.30 | L7 + LOST BET ″B″ = L8 = 1,231.45 (TOT. LOST) | |
| | TW8 + B = W8 | 854.3 + 427.15 = 1,281.45 TOTAL $ WON/TO WIN |

Table 3 below is a composite of the calculations performed for the eight races above, assuming 2 to 1 ODDS for each RACE and a $50.00 TO WIN entry.

TABLE 3

| “TO WIN” ($) | “BET” ($) | “WON” ($) | “LOST” ($) | RACE # |
|---|---|---|---|---|
| 50.00 | 25.00 | 75.00 | 25.00 | 1 |
| 50 + 25 | 37.50 | 112.50 | 62.50 | 2 |
| 50 + 62.50 | 56.25 | 168.75 | 118.75 | 3 |
| 50 + 118.75 | 84.375 | 253.125 | 203.13 | 4 |
| 50. + 203.13 | 126.563 | 379.688 | 329.69 | 5 |
| 50 + 329.69 | 189.84 | 569.53 | 519.53 | 6 |
| 50 + 519.53 | 284.77 | 854.30 | 804.30 | 7 |
| 50 + 804.30 | 427.15 | 1,281.45 | 1,231.45 | 8 |

The above figures in dollars and cents are calculated results based upon the odds. Race tracks pay out winnings in dollars and cents, but only accept BET(S) in dollars. Therefore, the BET in dollars and cents shown in Table 2 should be brought to the nearest highest dollar equally divisible by 2 or 5 to be accepted at some race tracks. To correct the BET amounts in Table 2, the program can include an additional step to place an acceptable bet. The program is corrected in the following manner.

The sequence of operations to be followed for the display functions and the keyboard in conjunction with Table 2 solve the mathematical problems of the many entry variations of the program expressed as TW:B::C:D. The program performs calculations for the “BET” amount (B), “LOST” amounts (L), and “WON” amounts (W) based upon entry of a “TO WIN” amount (TW) and “ODDS” (C:D). However, typical race tracks accept “BETS” in increments of 2 or 5 dollars, while paying out in dollars and cents. Therefore, if the calculated “BET” amount is in dollars or dollars and cents not equally divisible by and in increments of 2 or 5 dollars, it is referred to as “B−”. Corrections are made to “B−” with the incremental increase of “X” cents or dollars and cents to the nearest highest dollar equally divisible by and in increments of 2 or 5 to equal “B” (“B−”+“X”=B), and requiring the recalculation of the “TO WIN” amount. Steps 1 and 2 perform the corrections for “B” and “TO WIN (TW)” amounts as appropriate.

STEP #1—Enter the RACE 1 predetermined “TO WIN” (TW) amount and the “ODDS” called for by the display. When “BET B” is calculated to be a whole number in increments of 2 or 5, it is an acceptable “BET” and is displayed under “BET”, and the “TO WIN” (TW) amount is accepted (as in TABLE 4, RACE 1). The sum of the “BET” and “TO WIN” numerical amounts are stored into the memory until recalled as a “WON” when the “W” key is pressed for that RACE. (e.g., **TW+B=W1 RACE 1, **TW2+B=W2 for RACE 2, etc.) If after entering the “TO WIN” (TW) amount and the “ODDS” (C:D), if the calculated “BET” is in dollars and cents it is an unacceptable “BET” and referred to as “B−”, automatically calling for the addition of “X”, an incremental increase in cents or dollars and cents to the next highest dollar equally divisible by and in increments of 2 or 5 to equal “B” (“B−”+“X”=“B”) as in TABLE 4, RACE 2. The recalculated “BET B” is displayed. When “B−” is converted to “B”, a change is required for the “TO WIN” (**TW) as shown in Step 2. The RACE 1 predetermined “TO WIN” numerical entry can only be changed if the recalculated “B” requires its recalculation, or unless the user changes the “TO WIN” value before entered into memory.

STEP #2—After “B” was recalculated to be a whole number in increments of 2 or 5, Step 2 requires *TW2 (in the program *TW2:B::C:D) to be recalculated as a **TW2 in the program **TW2:B::C:D where “B” and “C:D” are known (TABLE 4, RACE 2). The recalculated **TW2 amount is added to the “B” amount and stored into memory for that RACE until recalled when the “W” key is pressed and the sum amount is displayed in the WON” and “TO WIN” display, (e.g., TABLE 4, RACE 2, **TW2+B=W2). The RACE 1, “TO WIN” amount cannot be changed after RACE 1, after it was an accepted, or recalculated amount. For RACE 2 and up the RACE 1 “TO WIN” (TW) is added to the RACE 1 “LOST BET B” amount when the “L” key is pressed and becomes a RACE 2, TW2* (TABLE 4) displayed amount, and used in the program *TW2: B::C:D (Table 4) awaiting the “ODDS” entry for the calculation of “B” in Step 1. NOTE:—When calculating for “B” AND “TW” for RACES 1 through 8 and upward, STEPS #1 and #2 can automatically be incorporated as the first calculation performed in the program TW:B::C:D shown in Table 4 for each race.

TABLE 4

| “TO WIN” ($) | 2:1 “ODDS” for each Race | | | Race |
|---|---|---|---|---|
| 50 = TW | *TW:B::C:D | 50:B::2:1 | Step 1* | 1 |
| | TWD = BC | 50 = 2B | | |
| | TWD −/− C = B | 50 −/− 2 = 25 = “B” (increment of 5) | | |
| | BET “B” = 25 or LOST BET “B” (LI) (TOT. LOST ) | | | |
| | **TW + B = W1 | 50 + 25 = 75 TOTAL $ WON/TO WIN | | |
| TW + LI = TW2* | *TW2:B::C:D | 75:B::2:1 | Step 1* | 2 |
| 50 + 25 = 75 | *TW2D = BC | 75 = 2B | | |
| **TW2 = 76 | *TW2D −/− C = B | 75 −/− 2 = 37.50 = B−(not incremental of 2 or 5) | | |
| | (B−) + X = B | 37.50 + 0.50 = 38 = “B” or LOST BET B | | |
| | L1 + LOST BET “B” = L2 | 25 + 38 = 63 (L2) TOTAL $ LOST | | |
| | **TW2:B::C:D | TW2:38::2:1 | Step 2** | |
| | **TW2D = BC | TW2 = 76 | | |
| | **TW2 + B = W2 | 76 + 38 = 114 TOTAL $ WON/TO WIN | | |
| TW + L2 = TW3* | *TW3:B::C:D | 113:B::2:1 | Step 1* | 3 |
| 50 + 63 | *TW3D = BC | 113 = 2B | | |
| **TW = 116 | *TW3D −/− C = B | 113 −/− 2 = 56 . . . 50 = B− | | |
| | (B−) + X = B | 56.50 + 1.50 = 58 = B or LOST BET B | | |
| | L2 + LOST BET B = L3 | 63 + 58 = 121 (L3) TOTAL $ LOST | | |
| | **TW3:B::C:D | TW3:58::2:1 | Step 2** | |
| | **TW3D = BC | TW3 = 58 × 2 = 116 | | |
| | **TW3 + B = W3 | 116 + 58 = 174 TOTAL $ WON/TO WIN | | |
| TW + L3 = TW4* | *TW4:B::C:D | 171:B::2:1 | Step 1* | 4 |
| 50 + 121 | *TW4D = BC | 171 = 2B | | |
| **TW4 = 172 | *TW4D −/− C = B | 171 −/− 2 = 85.50 = B− | | |
| | (B−) + X = B | 85.50 + 0.50 = 86 = B OR LOST BET B | | |
| | L3 + LOST BET B = L4 | 121 + 86 = 207 (L4) TOT. $ LOST | | |
| | **TW4:B::C:D | TW4:86::2:1 | Step 2** | |
| | **TW4D = BC | TW4 = 86 × 2 = 172 | | |
| | **TW4 + B = W4 | 172 + 86 = 258 TOTAL $ WON/TO WIN | | |
| TW + L4 = TW5* | *TW5:B::C:D | 257:B::2:1 | Step 1* | 5 |
| 50 + 207 | *TW5D = BC | 257 = 2B | | |
| **TW5 = 260 | *TW5D −/− C = B | 257 −/− 2 = 128.50 = 8− | | |
| | (B−) + X = B | 128.50 + 1.50 = 130 = B or LOST BET B | | |
| | L4 + LOST BET B = L5 | 207 + 130 = 337 TOT$ LOST | | |
| | **TW5:B::C:D | TW5:130::2:1 | Step 2 | |
| | **TW5D = BC | TW5 = 130 × 2 = 260 | | |
| | *TW5 + B = W5 | *260 + 130 = 390 TOTAL $ WON/TO WIN | | |
| TW + L5 = TW6* | *TW6:B::C:D | 387:B::2:1 | Step 1* | 6 |
| 50 + 337 | *TW6D = BC | 387 = 2B | | |
| **TW6 = 388 | *TW6D −/− C = B | 387 −/− 2 = 193.50 = B− | | |
| | (B−) + X = B | 193.50 + 0.50 = 194 = B or LOST BET B | | |
| | L5 + LOST BET B = L6 | 337 + 194 = 531 TOT $ LOST | | |
| | **TW6:B::C:D | TW6:194::2:1 | Step 2** | |
| | **TW6D = BC | TW6 = 194 × 2 = 388 | | |
| | **TW6 + B = W6 | 388 + 194 = 582 TOTAL $ WON/TO WIN | | |
| TW + L6 = TW7* | *TW7:B::C:D | 581:B::2:1 | Step 1* | 7 |
| 50 + 531 | *TW7D = BC | 581 = 2B | | |
| **TW7 = 584 | *TW7D −/− C = B | 581 −/− 2 = 290.50 = B− | | |
| | (B−) + X = B | 290.50 + 1.50 = 292 = B or LOST BET B | | |
| | L6 + LOST BET B = L7 | 531 + 292 = 823 TOT $ LOST | | |
| | **TW7:B::C:D | TW7:292::2:1 | Step 2** | |
| | **TW7D = BC | TW7 = 292 × 2 = 584 | | |
| | **TW7 + B = W7 | 584 + 292 = 876 TOTAL $ WON/TO WIN | | |
| TW + L7 = TW8* | *TW8:B::C:D | 873:B::2:1 | Step 1 | 8 |
| 50 + 823 | *TW8D = BC | 873 = 2B | | |
| **TW8 = 876 | *TW8D −/− C = B | 873 −/− 2 = 436.50 = B− | | |
| | (B−) + X = B | 436.50 + 1.50 = 438 = B or LOST BET B | | |
| | L7 + LOST BET B = L8 | 823 + 438 = 1,261 (L8) TOT. $ LOST | | |
| | **TW8:B::C:D | TW8:438::2:1 | Step 2** | |
| | **TW8D = BC | TW8 = 438 × 2 = 876 | | |

| | |
|---|---|
| **TW8 + B = W8 | 876 + 438 = 1,314 TOTAL $ WON/TO WIN |

Table 5 below is a composite of the above calculations performed for the eight races using Steps #1 and #2 above to calculate “B”, a number that is equally divisible by 2 or 5 to the nearest highest dollar, and to recalculate **“TW” (TO WIN) after “B” was calculated. The calculation is necessary since some race tracks only accept a bet in dollars only and only in increments of 2 or 5. The BET (B−) numbers in parenthesis are the calculated numbers, adjacent to the corrected numbers (B−)+X=B that are equally divisible by 2 or 5. The “TO WIN” numbers in parenthesis are the calculated numbers adjacent to the corrected **“TO WIN” number.

TABLE 5

| **“TO WIN” | “BET” | “WON” | “LOST” | RACE |
|---|---|---|---|---|
| ($) | ($) | ($) | ($) | # |
| 50.00* | 25.00 | 75.00 | 25.00 | 1 |
| **76.00 (75.00)* | 38.00 (37.50) | 114.00 | 63.00 | 2 |
| **116.00 (113.00)* | 58.00 (56.50) | 174.00 | 121.00 | 3 |
| **172.00 (171.00)* | 86.00 (85.50) | 258.00 | 207.00 | 4 |
| **260.00 (257.00)* | 130.00 (128.50) | 390.00 | 337.00 | 5 |
| **388.00 (387.00)* | 194.00 (193.50) | 582.00 | 531.00 | 6 |
| **584.00 (581.00)* | 292.00 (290.50) | 876.00 | 823.00 | 7 |
| **876.00 (873.00)* | 438.00 (436.50) | 1,314.00 | 1,261.00 | 8 |

(Note:
as a reference, 876.00 + 438.00 = 1314.00 or **TW8 + B = W8).

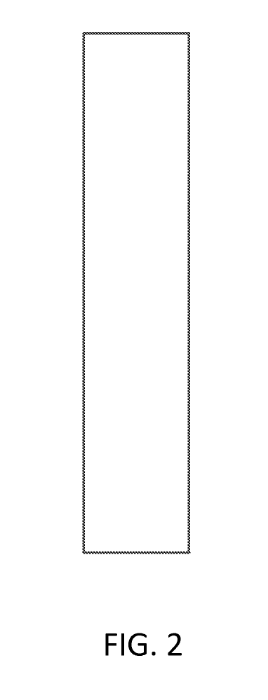

Referring to FIGS. 3-8, there is shown a race track betting calculator 33 constructed in accordance with a second exemplary embodiment of the present inventions. The embodiment of the calculator 5 with a six (6) line display function of FIG. 1 can be modified to have fewer than six lines, wherein the lines of the display are scrolled.

The battery powered hand held electronic calculator 33 can have standard electronic functions of the basic calculation operations of addition, subtraction, multiplication and division with an exponential or non-exponential display and temporary power-off function. The calculator 33 is modified to incorporate as part of the electronics 6 a program incorporated into the memory of a processor 35 that dictates a set of instructions to and from a three line flashing function display 34, with numerical entries entered via a keyboard 9.

The calculator 33 has a flashing function display 34 which includes a “TO WIN” field 19 with an eight digit numerical entry 20, an “ODDS” field 21 with a three digit numerical entry 22, a “TO” designation 23 surrounded by two numerical entries 24, a “BET” field 25 with an eight digit numerical entry 26, a “LOST” field 27 with an eight digit numerical entry 28, a “WON” field 29 with an eight digit numerical entry 30, and a “RACE” field 31 with a two digit numerical entry 32.

Referring now to FIG. 3, the calculator 33 has keyboard 9 with numerals 10 from zero (0) to nine (9) and six function keys 11 a “TO” key 12 used to separate an “ODDS” numeric entry 22 from an “ODDS” numeric entry 24, an “E” key 13 functioning as an “enter” key, a “C” key 14 functioning as a “clear” key, an “AC” key 15 for starting the calculator 33, an “L” key 16 for activating the “LOST” field of the display 34 and a “W” key 17 for activating the “WON” field of the display 34. The C/AC keys 18 can be operated together or one after the other to shut down the calculator 33. The “TO” key 12 and the “E” key 13 can be pressed simultaneously (or in that order) to provide a temporary power-off of the calculator 33 while the calculator 33 retains its memory and last state. To restore power, memory, and last state, the “AC” key 15 is then pressed. The calculator 33 can also be provided with standard electronic function keys (not shown) for the basic calculation operations of addition, subtraction, multiplication and division, and/or other keys which may appear on a standard typewriter-like keyboard or which may be found on a cell phone, or any portable wireless device with or without expansion card capability and having a display with an alphanumeric and other functions keyboard, hand-held device, e.g., a Blackberry® device, etc.

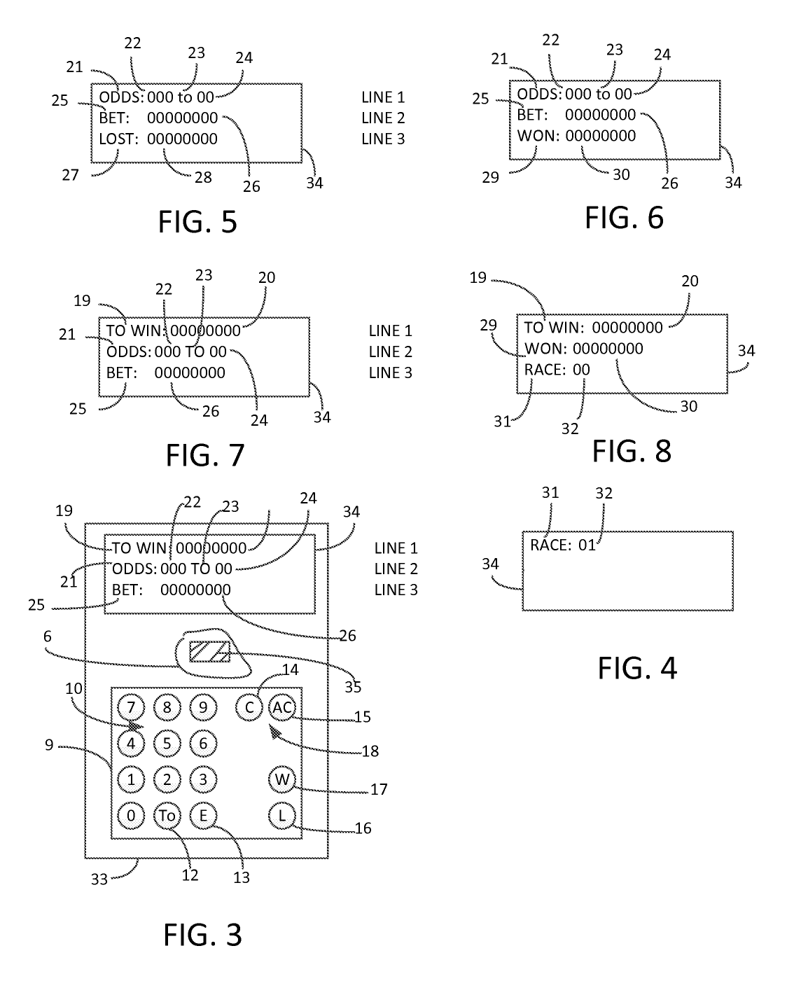

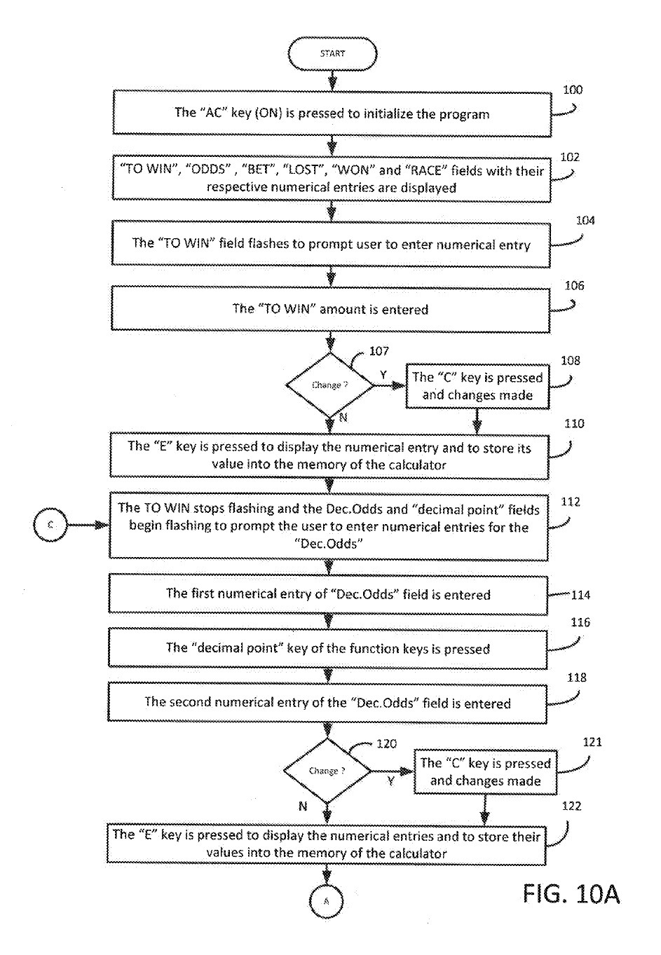

FIGS, 10A-10C are three parts of a continuous flow chart of the steps executed by the main program stored in the memory (not shown) of the processor 35 of the calculator 33. Referring now to FIGS. 3 and 8, at step 200, the “AC” key 15 (ON) of the calculator 33 is pressed, which cause the processor 35 to start the commands of the program and to light the display 34. At step 201, the “RACE” field 31 and the numerical entry 32 preferably display a “01” for the start of the first race or “RACE” entry as shown in “LINE 1” of FIG. 4. The “RACE” field 31 and its numerical entry 32 is preferably displayed for 6 seconds. Thereafter, at step 202 (see FIG. 3), the display 34 lights up and the LINE 1, “TO WIN” 19 flashes calling for a numerical entry 20 by the user using the keyboard numerals 10. At step 204, the user enters numerical entry 20 by pressing the keyboard numerals 10, which causes the numerical entry 20 to be displayed. If, at step 206, a change is to be made, then at step 208, the C key 14 is pressed using the function keys 11 to clear the numerical entry 20. The user enters the new numerical entry 20. If there were no changes to be made or the user has already entered changes, then at step 210, the “E” key 13 from the function keys 11 is pressed, entering the numerical entry 20 into the memory of the processor 35 of the calculator 33, displaying numerical entry 20 in to the display 34.

At step 211, the processor 35 causes the “TO WIN” field 19 to stop flashing and starts the LINE 2, “ODDS” field 21 and the “TO” designation 23 to start flashing, thereby calling for the user to make numerical entries 22, 24 at the keyboard 9. At step 212, the first numerical entry 22 for the “ODDS” function 21 can be entered, the “TO” key 12 from the function keys 11 is pressed, and the numerical entry 24 is entered using the keyboard numerals 10.

If at step 213, changes are to be made, then at step 214, the “C” key 14 from the function keys 11 is pressed to clear the entries 22, 24. The user can then enter values as stated above. If no changes were to be made, or if they had already been made, then at step 216, the “E” key 13 is pressed, to display the numerical entries in the display 34 and to enter it into the memory of the processor 35 of the calculator 33.

At step 217, the processor 35 causes the “ODDS” fields 21, 23 to stop flashing and causes the “BET” field 25 to start flashing, and starts the program to automatically flash the LINE 3 “BET” field 25 while calculating and displaying the “BET” numerical entry 26. In addition, the processor 35 calculates or recalculates a “BET” amount in increments of 2 or 5 dollars to the nearest highest dollar. When the “BET” amount is in increments of 2 or 5 dollars, it is an accepted calculated “BET”, which is added to the calculated “TO WIN” (**TW) and stored into memory until recalled as a “WON” entry for that RACE. When the “BET” is not in increments of 2 or 5 dollars, the “BET” is recalculated, and rounded up to the nearest highest 2 or 5 dollars. This prompts the recalculation of the “TO WIN” (**TW), added together, and stored into memory of the processor 35 until recalled as a “WON” entry for that RACE. The “BET” amount is displayed at the “BET” numerical entry of the display 34 until recalled as a “WON” entry for that RACE.

At step 218, for last minute changes to the “ODDS” entries 22, 24 and BET entry 26 BEFORE the “E” key 13 is pressed. At step 219, the “C” key 14 from the function keys 11 is pressed two (2) times to clear the last “ODDS” and “BET” entries. The user can then enter the new “ODDS” 22, 24 as described above to calculate a “BET” amount. At step 220, the user can place the “BET” numerical entry 26 at the RACE track booth. Then, at step 221, the “E” key 13 from the function keys 11 is pressed, which causes the processor 35 to stop the “BET” field 25 from flashing. The processor 7 also stores the “BET” numerical entry 26 into the memory of the processor 35, for subsequent use as “Lost BET B.” Another result of pressing the “E” key 13 is that there is a shift and change in the display 34. LINE 1 displays the “ODDS” field 21, LINE 2 displays the “BET” field 25.

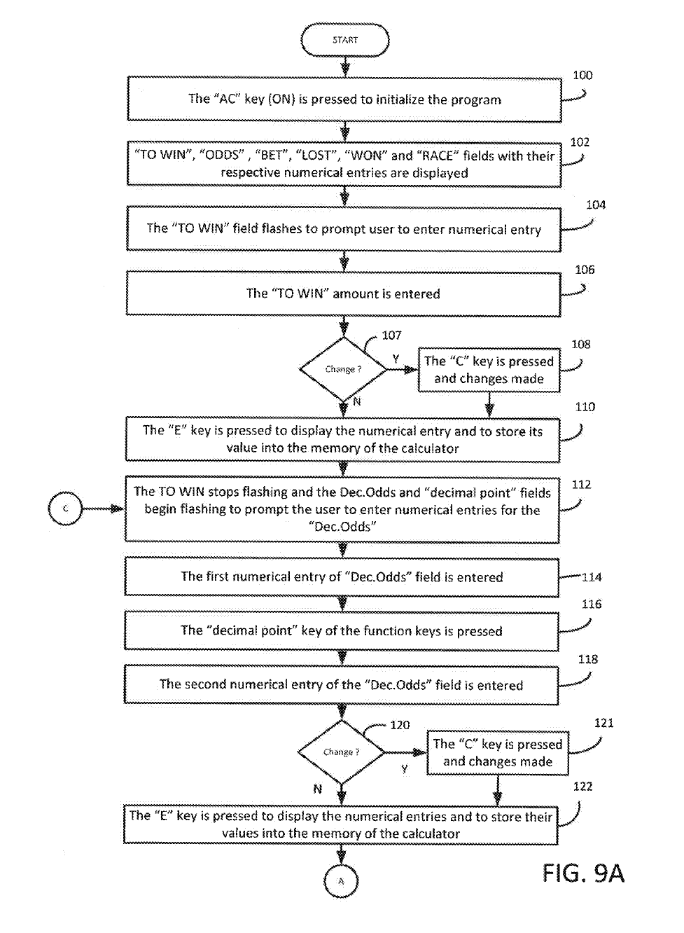

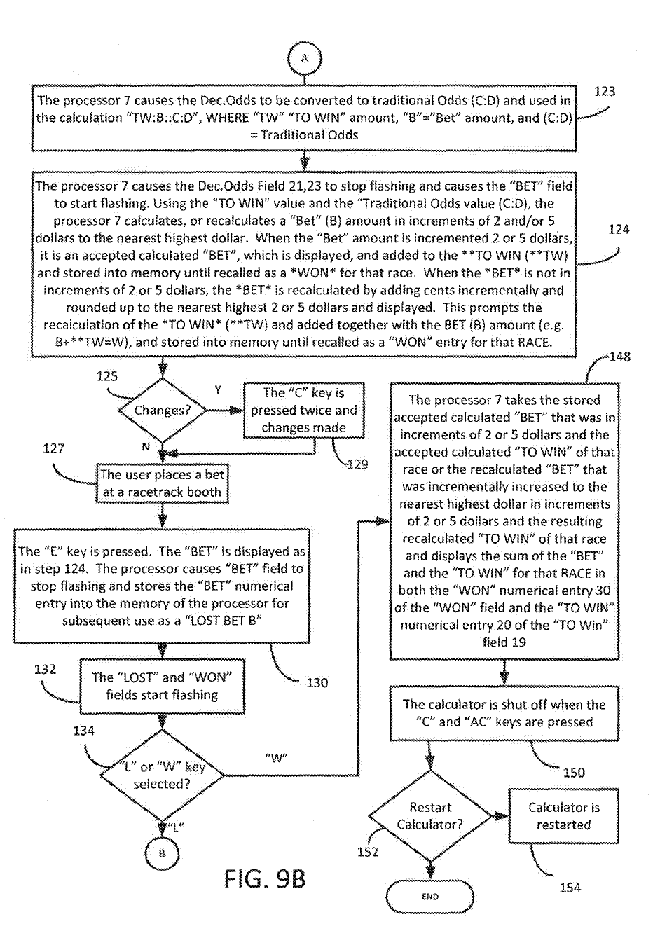

At step 222, LINE 3 becomes an alternating flashing “LOST” field 27 or a flashing “WON” field 29 as shown in the displays of FIG. 5 and FIG. 6. The processor 35 awaits the user to determine whether the BET numerical entry 26 was LOST or WON, whereby either the “L” key 16 or the “W” key 17 from the function keys 11 is pressed. At step 223, if the USER selects the “LOST” function 27 by pressing the “L” key 16 from the function keys 11, the following steps are executed by the processor 35 in the calculator 33:

At step 224, the BET numerical entry 26 is taken from the memory of the processor 35 and is displayed as a LOST BET B numerical entry 28 in the LOST field 27. The LOST numerical entry 28 becomes additive for subsequent RACES and displayed. For example, the program for the LOST TOTAL numerical entry 28 is as follows:

RACE 1: L1,

RACE 2: L1+LOST BET B=L2,

RACE 3: L2+LOST BET B=L3,

RACE 4: L3+LOST BET B=L4,

RACE 5: L4+LOST BET B=L5,

RACE 6 L5+LOST BET B=L6,

RACE 7: L6+LOST BET B=L7,

RACE 8: L7+LOST BET B=L8, etc.

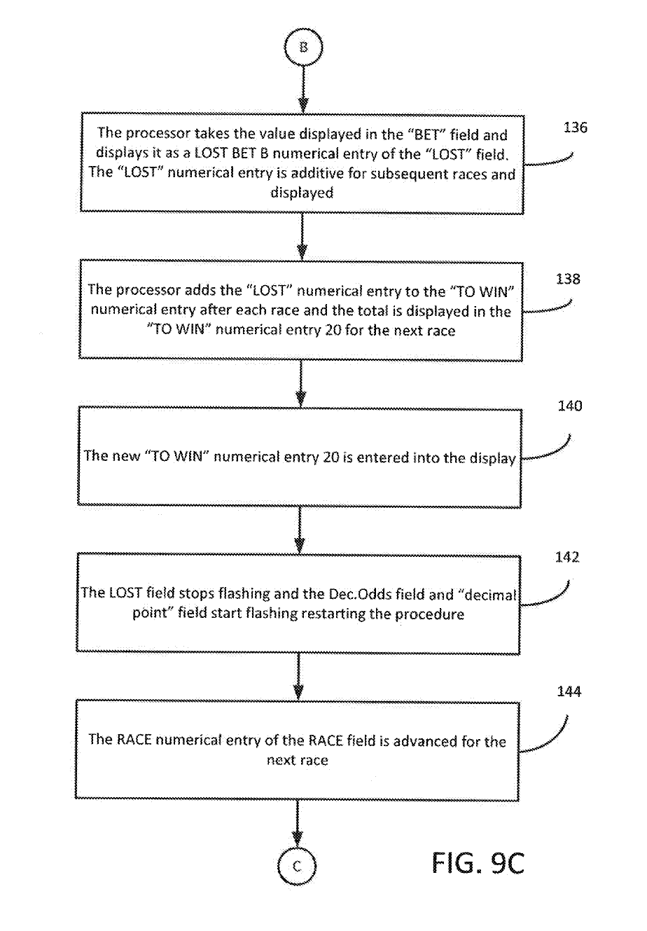

At step 226, the “LOST” numerical entry is added to the “TO WIN” numerical entry after each “RACE” and is displayed in the “TO WIN” numerical entry 20 (as in FIG. 7) (RACE 01 “TO WIN” numerical entry+RACE 01 “LOST” numerical entry=RACE 02 “TO WIN” numerical entry. RACE 01 “TO WIN” numerical entry+RACE 02 “LOST” numerical entry=RACE 03 “TO WIN” numerical entry, etc.) The program is expressed as:
RACE 1: TW,
RACE 2: TW+L1=TW2*,
RACE 3: TW+L2=TW3*,
RACE 4: TW+L3=TW4*,
RACE 5: TW+L4=TW5*,
RACE 6: TW+L5=TW6*,
RACE 7: TW+L6=TW7*,
RACE 8: TW+L7=TW8*, etc.

At step 230, the flashing “LOST” field 27 and the LOST numerical entry 28 is preferably displayed for 6 seconds, thereafter automatically shifting the display 34 to as the next RACE entry 02 (See FIG. 4), for the second RACE or event, in the RACE numerical entry 32 of the RACE field 31. (After each RACE or event, the RACE numerical entry 32 is advanced to the next higher number).

At step 232, the RACE” field 31 and the RACE numerical entry 32 is displayed for preferably 6 seconds, thereafter automatically shifting the display 34 to FIG. 7 (same as in FIG. 3). The “TO WIN” field 19 DOES NOT FLASH and the RACE 2 “TO WIN” numerical entry 20 became the sum of the RACE 1 TO WIN numerical entry 20 plus the RACE 1 LOST TOTAL numerical entry 28. In some embodiments, no further changes can be made to the RACE 1 TO WIN numerical entry 20 by the user, after the BET as been placed.

At step 234, the “ODDS” fields 21, 23 start flashing as shown in FIG. 7 of the display 34, calling for the user to enter ODDS numerical entries 22, 24, restarting the procedure as outlined above. At step 236, the RACE numerical entry of the “RACE” field is advanced for the next race.

At step 223, if the user determined that the RACE was WON, the “W” key 17 from the function keys is pressed. Then at step 238 from the memory of step 217, the processor 35 takes the stored accepted calculated “BET” that was in increments of 2 or 5 dollars, and the accepted calculated “TO WIN” of that RACE (or the recalculated “BET” that was incrementally increased to the nearest highest dollar in increment of 2 or 5 dollars and the resulting recalculated “TO WIN” of that RACE), and displays the sum of the “BET” and “TO WIN” of either one for that RACE in both the “WON” numerical entry of the “WON” field and the TO WIN” numerical entry of the “TO WIN” field as shown in FIG. 8. Both the “WON” and “TO WIN” fields start flashing. The “WON” program is expressed as:

RACE 1: **TW+BET B=WI,

RACE 2: **TW2+BET B numerical entry 26=W2,

RACE 3: **TW3+BET B numerical entry 26,=W3

RACE 4: **TW4+BET B numerical entry 26=W4,

RACE 5: **TW5+BET B numerical entry 26,=W5

RACE 6: **TW6+BET B numerical entry 26=W6,

RACE 7: **TW7+BET B numerical entry 26=W7,

RACE 8: **TW8+BET B numerical entry 26=W8, etc.

The last RACE entry is displayed as in FIG. 8. In some embodiments, no further entries can be made as the USER has made his TO WIN/WON GOAL. In such circumstances, at step 240, the user shuts down the calculator 33 by pressing the “C” key 14 and the “AC” key 15 simultaneously or one after the other. If, at step 242, the user desires to start another round of betting, then at step 244, the “AC” key 15 is pressed again.

In a preferred embodiment, the calculator 33 can be temporarily shut off while retaining its memory and last state in the display 34. This is accomplished by pressing the “TO” key 12 and the “E” key 13 simultaneously (or in that order). To restore power, memory, and the last state of the display 34, the “AC” key 15 is pressed by the user.

The present invention has numerous advantages over prior art calculators. For instance, the present invention utilizes a new principle of operation for the progressive method of placing a bet with its program designed to make complex calculations instantaneously with one entry. The calculator of the present invention uses fewer keys than a conventional calculator, and simplifies operations requiring several steps by employing sequential flashing of entries and automatic calculations of intermediate results. The sequential flashing display directs the user to perform step by step operations with a single key entry eliminating repetitive operations of multiplication, division, addition and memory functions required of standard calculators and without fear of omissions of any of the steps required by the program. Some calculators utilize the AC key as the ON/OFF switch, while others incorporate separate ON/OFF keys. Although the present invention may use either approach, thought has been given to preserve the entries made of the many races where an accidental swipe of an OFF key deletes all data stored in the memory. The preferred embodiment of the present invention utilizes two keys that may be pressed simultaneously to minimize the accidental deletion of data stored in the memory. The “TO” and “E” keys can be pressed together to function as a temporary power-off of the calculator while maintaining the current state of its memory of the display and display status. To restore the calculator to its current state, the “AC” key is pressed which restores the last display and status of the calculator.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The above presents a description of a best mode contemplated for carrying out the present invention, and of the manner and process of making and using them, in such full, clear, concise, and exact terms as to enable any person skilled in the art to which it pertains to make and use these devices and methods. The present invention is, however, susceptible to modifications and alternative method steps from those discussed above that are fully equivalent. Consequently, the present invention is not limited to the particular embodiments disclosed. On the contrary, the present invention encompasses all modifications and alternative constructions and methods coming within the spirit and scope of the present invention.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function, it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A computer-implemented method for progressive betting comprising the steps of:
receiving a first entry from a user corresponding to a TO WIN value;
receiving a second entry from the user corresponding to an ODDS value;
determining in a computer without intervention of the user, a BET value representative of an amount to bet for a single race entrant for an entrant race from the first entry and the second entry; and communicating the BET value to the user;
accepting the BET value and accepting the TO WIN value if the BET value for the entrant race is evenly divisible by at least one of 2 or 5 dollars; and
increasing the BET value to a first nearest dollar divisible by at least one of 2 or 5 dollars if the BET value for the entrant race is unevenly divisible by one of 2 dollars or 5 dollars and;
accepting the increased BET value,
recalculating the TO WIN value in accordance with the increased BET value, and
accepting the recalculated TO WIN value.

2. The method of claim 1, further including the step of adding the accepted BET value to the accepted TO WIN value to derive a WON value if the BET value for the entrant race is evenly divisible by at least one of 2 or 5 dollars.

3. The method of claim 1, further including the step of adding the accepted increased BET value to the accepted recalculated TO WIN value to derive a WON value if the BET value for the entrant race is unevenly divisible by one of 2 or 5 dollars.

4. The method of claim 1, further including the step of adding either the accepted BET value, or, the accepted increased BET value to a LOST value if the user loses a bet.

5. The method of claim 1, further including the step of determining a second TO WIN value from a LOST BET value if a “LOST” function has been initiated.

6. The method of claim 5, further including the steps of receiving a third entry from the user corresponding to a second ODDS value if the LOST function has been initiated; and
restarting the procedure from the odds value, for a single entrant for a second entrant race;
determining from the second TO WIN value and the second ODDS value a second BET value, without intervention of the user, and representative of a second amount to bet.

7. The method of claim 6, further including the step of communicating the second BET value to the user.

8. The method of claim 6, further including the steps of accepting the second BET value if the second BET value is evenly divisible by at least one of 2 or 5 dollars, or accepting the second BET value after increasing same to a second nearest dollar that is evenly divisible by at least one of 2 dollars or 5 dollars if the second BET value is unevenly divisible by at least one of 2 dollars or 5 dollars.

9. The method of claim 8, accepting the TO WIN value if the second BET value is evenly divisible by least one of 2 dollars or 5 dollars, and recalculating the TO WIN value in accordance with the increased BET value if the second BET value is unevenly divisible by at least one of 2 dollars or 5 dollars and accepting the recalculated TO WIN value.

10. The method of claim 8, further including the step of determining a third TO WIN value from the TO WIN value and a second LOST BET value if the LOST function has again been initiated.

11. The method of claim 1, further including the step of displaying a RACE value for the first race and advancing automatically to the next RACE value when the LOST function is initiated.

12. The method of claim 1, including the step of contemporaneously displaying at least one of the TO WIN value, the ODDS value, the BET value, a RACE value, and one of a LOST value and a WON value.

13. The method of claim 1, adapted for progressive betting, including the steps of displaying a RACE value, and scrolling to contemporaneously display the TO WIN value, the ODDS value, the BET value; and, scrolling to contemporaneously display the ODDS value, the BET value, the LOST value; and, scrolling to contemporaneously display the ODDS value, the BET value the WON value; and, upon entry of a LOST BET value, scrolling for a second RACE value: and scrolling to contemporaneously display a second TO WIN value, the ODDS value, the BET value, and, scrolling to contemporaneously display the ODDS value, the BET value, the LOST value; and scrolling to contemporaneously display the ODDS value, the BET value, the WON value; and scrolling to contemporaneously display a TO WIN value, a WON value and a RACE value, when the user arrived at a win, and where the WON and TO WIN values flash. No further entries may be made.

14. The method of claim 1 wherein the computer-implemented method for progressive betting is configured for a horse race having horse entrants.

15. The method of claim 1 wherein the computer-implemented method for progressive betting is configured for use with UNITED STATES DOLLARS.

16. A computer program product comprising a computer useable medium having control logic stored therein for causing a computer to generate feedback for progressive betting for a first entry corresponding to a TO WIN value and a second entry from the user corresponding to an ODDS value, said control logic comprising:
first computer readable program means for causing the computer to determine from the first entry and the second entry a BET value representative of an amount to bet for a single horse for a horse race,
second computer readable program means for causing the computer to accept the BET value and accept the TO WIN value if the BET value is evenly divisible by at least one of 2 dollars or 5 dollars; and
third computer readable program means for causing the computer to accept the BET value after increasing same to a first nearest dollar that is evenly divisible by at least one of 2 dollars or 5 dollars if the BET value is unevenly divisible by at least one of 2 dollars or 5 dollars and recalculate the TO WIN value in accordance with the increased BET value, and accept the recalculated TO WIN value; wherein the control logic under the control of the computer program product is configured to cause the computer to, upon initiation of a LOST function, to determine a second TO WIN value from a LOST BET value; and wherein the control logic under the control of the computer program product is further configured to cause the computer to, upon initiation of a WON function, determine a WON value from at least the TO WIN value.

17. The computer program product of claim 16, wherein the control logic under the control of the computer program product is further configured, upon initiation of the WON function, determine the WON value by summing the TO WIN with the BET value.

18. A computer-readable medium having stored thereon computer-executable instructions for performing the steps of the following method; receiving a first entry from a user corresponding to a TO WIN value; receiving a second entry from the user corresponding to an ODDS value; without intervention of the user, determining from the first entry and the second entry in accordance with progressive betting a BET value representative of an amount to bet for a single horse for a horse race; and communicating the BET value to the user; if the BET value is evenly divisible by one of 2 dollars or 5 dollars, accepting the BET value and accepting the TO WIN value; and, if the BET value is unevenly divisible by one of 2 dollars or 5 dollars, increasing the BET value to a first nearest dollar divisible by one of 2 dollars or 5 dollars, accepting the increased BET value, recalculating the TO WIN value in accordance with the increased BET value, and accepting the recalculated TO WIN value.
